(19) United States
(12) Patent Application Publication
(10) Pub. No.: US 2026/0268523 A1
(43) Pub. Date: Sep. 10, 2026

(54) CALIBRATION OF AN INFRARED CAMERA

(71) Applicant: GDM Holding LLC, Mountain View, CA (US)

(72) Inventors: Hiu Hong Yu, Fremont, CA (US); Grace Vesom, Atherton, CA (US); Christine W.Y. Chan, Menlo Park, CA (US); Sherry Qianhong Moore, Palo Alto, CA (US)

(21) Appl. No.: 19/072,479

(22) Filed: Mar. 6, 2025

(51) Int. Cl. G06T 7/80; G06T 5/70

(52) U.S. Cl. CPC G06T 7/80; G06T 5/70; G06T 2207/10048; G06T 2207/20024

(57) ABSTRACT

Implementations are described herein for calibration of a long-wave an infrared camera. In various implementations, a system for actively calibrating a thermal camera may include: a calibration target including a plurality of infrared (IR) emitters; a thermal camera configured to capture a thermal image; and a computing device configured to: detect a pattern for each of the plurality of active IR emitters depicted in the thermal image; estimate a centroid of each pattern; and determine, via the centroid of each pattern, one or more camera calibration parameters for the thermal camera.

### BACKGROUND

Camera calibration is a fundamental process in computer vision, enabling accurate mapping between 3D world coordinates and 2D image pixels. Traditional methods often rely on passive calibration targets, such as checkerboards or circles, requiring external light sources and/or controlled environments. However, these methods face numerous challenges, including susceptibility to noise and illumination variations, which may lead to inaccuracies. These limitations hinder the performance of computer vision applications, particularly in thermal imaging where accurate calibration is crucial for temperature measurements and/or object recognition. Distortion introduced to cameras during manufacturing can significantly impact the performance of computer vision algorithms because the 3D location of a given point will be mapped incorrectly onto the 2D image plane. Moreover, the performance of passive calibrations is subject to limitations regarding the light source intensity and spatial layout of the passive calibration targets. Accurate intrinsic calibration is essential to the performance of applications in 3D vision and computer aided manufacturing (CAM) for accurate 3D object detection and segmentation. Therefore, a novel and efficient solution for passive calibration of 3D camera systems, in particular long-wave infrared (LWIR) camera systems, is highly desirable.

### SUMMARY

Implementations described herein relate to using active infrared (IR) calibration targets that include active IR emitters. Omnidirectional thermal dispersion caused by these emitters may be used to determine intrinsic and/or extrinsic parameters, and/or distortion, of a camera.

Active IR calibration targets implemented with selected aspects of the present disclosure provide various technical advantages that overcome challenges of passive calibration targets. Active IR calibration targets do not require an external IR source to heat the target. Moreover, they avoid unevenly distributed IR source due to inaccurate alignment, e.g. the left side of the target contains more energy than right side of the target. Active IR calibration targets also avoid the time constraints inherent with passive targets, such as IR energy discharging when the external IR source is removed, causing the IR signal to get weaker over time which limits the data collection duration. Furthermore, active IR calibration targets may avoid the inaccuracies in data collection caused by the IR energy discharge of passive IR calibration targets, e.g. due to the intensity of the passive calibration target differing from image to image, which affects the target detection consistency.

In a first aspect, a system for actively calibrating a thermal camera includes: a calibration target including a plurality of infrared (IR) emitters; a thermal camera configured to capture a thermal image; a computing device configured to: detect a pattern for each of the plurality of active IR emitters depicted in the thermal image; estimate a centroid of each pattern; and determine, via the centroid of each pattern, one or more camera calibration parameters for the thermal camera.

In some implementations, the computing device is coupled with the calibration target and is further configured to activate one or more of the plurality of IR emitters to disperse thermal energy. In some implementations, the computing device is coupled with the thermal camera and further configured to capture the thermal image. In some implementations, the computing device is further configured to compare the estimated centroid with a known location of a first of the plurality of IR emitters. In some implementations, the computing device is further configured to smooth the captured thermal image. In some implementations, the computing device is further configured to apply an intensity filter to the captured thermal image.

In some implementations, the one or more camera calibration parameters for the thermal camera includes one or more intrinsic parameters. In some implementations, the one or more camera calibration parameters for the thermal camera includes one or more extrinsic parameters.

In some implementations, the pattern detected is circular.

In some implementations, the calibration target is a black and white checkerboard. In some implementations, the plurality of IR emitters operate withing a specific temperature range that corresponds with an operating temperature range of the thermal camera.

In another aspect, a method of actively calibrating a thermal camera in which a calibration target contains a plurality of infrared (IR) emitters where the plurality of IR emitters are disposed on a calibration target including: activating the plurality of IR emitters disposed on the calibration target to disperse thermal energy; capturing, via the thermal camera, a thermal image of the calibration target; detecting a pattern for each of the plurality of IR emitters depicted in the captured thermal image; estimating a centroid of each pattern; and determining, via estimated centroid of each circular pattern, one or more camera calibration parameters for the thermal camera.

In some implementations, the determining one or more camera calibration parameters for the thermal camera further includes comparing the estimated centroid with a known location of a first of the plurality of IR emitters.

In some implementations, the method further comprises smoothing the captured thermal image. In some implementations, the method further comprises applying an intensity filter to the captured thermal image.

In some implementations, determining one or more camera calibration parameters for the thermal camera further includes determining one or more intrinsic parameters. In some implementations, determining one or more camera calibration parameters for the thermal camera further includes determining one or more extrinsic parameters.

In some implementations, the pattern detected is circular.

In some implementations, the calibration target is a black and white checkerboard.

In some implementations, the plurality of IR emitters operate withing a specific temperature range that corresponds with an operating temperature range of the thermal camera.

### BRIEF DESCRIPTION OF THE DRAWINGS

FIG. 1 is a simplistic schematic of a calibration system configuration according to an exemplary implementation.

FIG. 2 is a block diagram of a computing device according to an exemplary implementation.

FIG. 3 illustrates a calibration target with a plurality of active infrared emitters according to an exemplary implementation.

FIG. 4 illustrates another calibration target with a plurality of active infrared emitters according to another exemplary implementation.

FIG. 5 illustrates a detected calibration target with calibration control points according to an exemplary implementation.

FIG. 6 illustrates a method of actively calibrating a camera according to an exemplary implementation.

### DETAILED DESCRIPTION

The following detailed description, which references to and incorporates the drawings, describes and illustrates one or more specific embodiments. These embodiments, offered not to limit but only to exemplify and teach, are shown and described in sufficient detail to enable those skilled in the art to practice what is claimed. Thus, for the sake of brevity, the description may omit certain information known to those of skill in the art.

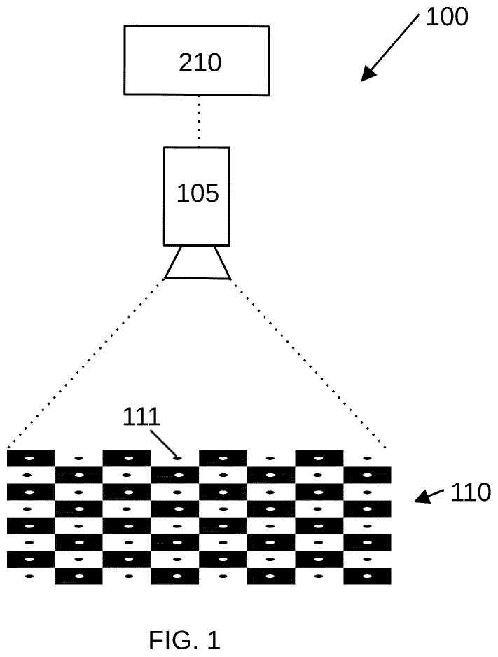

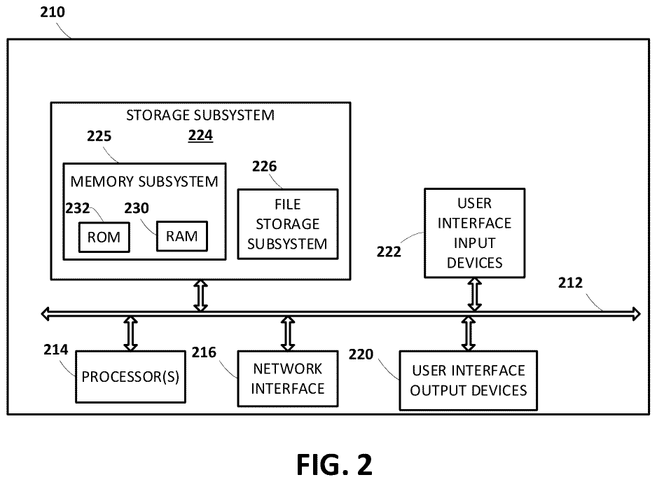

FIG. 1 is a simplistic diagram of a calibration system 100 for calibrating a camera 105 according to some implementations described herein. In some implementations, the camera 105 is implemented as a long wave infrared (LWIR) or thermal camera. As shown, the calibration system 100 includes a calibration target 110 that includes a plurality of infrared (IR) emitters 111 to activate and a camera 105. As used herein, IR emitters (e.g., 111) may be implemented using a variety of different components, e.g., light-emitting diode (LED) IR diodes or Chip on Board (COB) LED. The calibration system 100 also includes a computing device 210 (which will be described in more detail with reference to FIG. 2) that may be wired or wireless connected with the LWIR camera 105 and be utilized to perform one or more aspects of techniques described herein.

During calibration, the computing device 210 may be able to control the calibration target 110 to cause one or more of a plurality of IR emitters 111 (e.g., LED IR diodes or Chip on Board (COB) LED) to activate. Once activated, the IR emitters 111 emit infrared radiation, or alternatively, emit visible radiation. The computing device 210 may also be configured to operate the camera 105 and to receive thermal images of the calibration target 110 (including the activated IR emitters 111) from the camera 105.

The IR emitters 111 (e.g., LED IR Diodes, Chip on Board (COB) LED, etc.) are placed at a specific distance from each other, for example in a grid formation, on the calibration target 110. A specific distance between the IR emitters 111 and certain point on the calibration target 110 is determined. A specific temperature range is also determined for the IR emitters 111, for example within the operating temperature range of the camera 105 for thermal cameras. The computing device 210 may execute the calibration instructions to control the camera 105 to read or obtain an image at the camera LWIR 105. The computing device 210 may then detect a circular pattern depicted for each of the plurality of active IR emitters 111 on the acquired image. An estimate of a centroid of each circular pattern may be determined, for example, using a geometric algorithm. This geometric algorithm may consider, for example, the distance between centroids and a distance from the centroids to a closest edge of the calibration target in the image. The centroids of the circular patterns on the image may be used to estimate camera calibration intrinsic and distortion parameters for the camera 105.

FIG. 2 is a block diagram of an example computing device 210 that may optionally be utilized to perform one or more aspects of techniques described herein. In some implementations, one or more of a client device, cloud-based or wired camera component(s) (e.g., camera 105), and/or other component(s) may comprise one or more components of the example computing device 210.

Computing device 210 typically includes at least one processor 214 which communicates with a number of peripheral devices via bus subsystem 212. These peripheral devices may include a storage subsystem 224, including, for example, a memory subsystem 225 and a file storage subsystem 226, user interface output devices 220, user interface input devices 222, and a network interface subsystem 216. The input and output devices allow user interaction with computing device 210. Network interface subsystem 216 provides an interface to outside networks and is coupled to corresponding interface devices in other computing devices.

User interface input devices 222 may include a camera, a keyboard, pointing devices such as a mouse, trackball, touchpad, or graphics tablet, a scanner, a touchscreen incorporated into the display, audible input devices such as voice recognition systems, microphones, and/or other types of input devices. In general, use of the term “input device” is intended to include all possible types of devices and ways to input information into computing device 210 or onto a communication network.

User interface output devices 220 may include a display subsystem, a printer, a fax machine, or non-visual displays such as audible output devices. The display subsystem may include a cathode ray tube (CRT), a flat-panel device such as a liquid crystal display (LCD), a projection device, or some other mechanism for creating a visible image. The display subsystem may also provide non-visual display such as via audible output devices. In general, use of the term “output device” is intended to include all possible types of devices and ways to output information from computing device 210 to the user or to another machine or computing device.

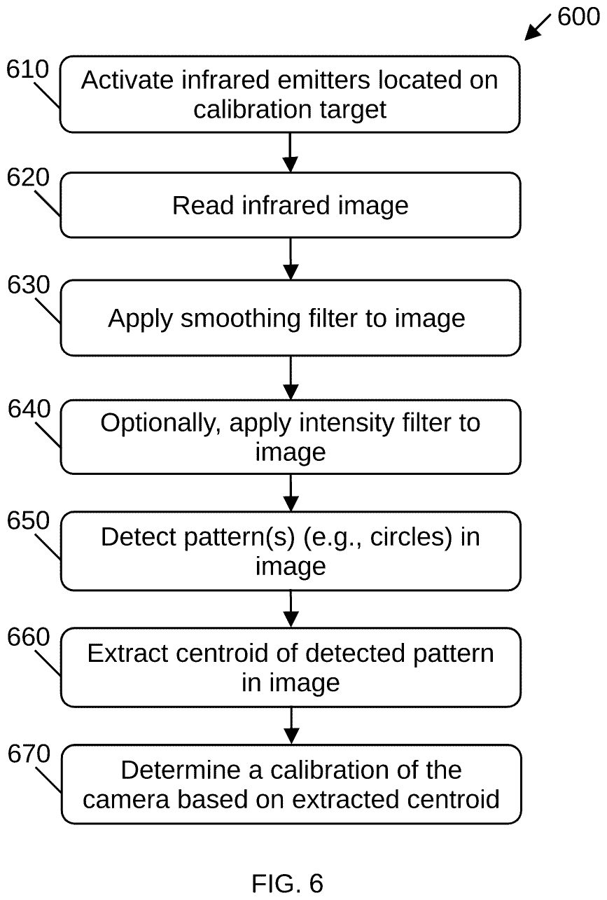

Storage subsystem 224 stores programming and data constructs that provide the functionality of some or all of the modules described herein. For example, the storage subsystem 224 may include the logic to perform selected aspects of the method of FIG. 6, as well as to implement various components, such as camera 105, IR emitter(s) 111, etc. that are depicted in and described with reference to FIG. 1.

These software modules are generally executed by processor 214 alone or in combination with other processors. Memory 225 used in the storage subsystem 224 can include a number of memories including a main random access memory (RAM) 230 for storage of instructions and data during program execution and a read only memory (ROM) 232 in which fixed instructions are stored. A file storage subsystem 226 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 226 in the storage subsystem 224, or in other machines accessible by the processor(s) 214.

Bus subsystem 212 provides a mechanism for letting the various components and subsystems of computing device 210 communicate with each other as intended. Although bus subsystem 212 is shown schematically as a single bus, alternative implementations of the bus subsystem may use multiple busses.

Computing device 210 can be of varying types including a workstation, server, computing cluster, blade server, server farm, or any other data processing system or computing device. Due to the ever-changing nature of computers and networks, the description of computing device 210 depicted in FIG. 2 is intended only as a specific example for purposes of illustrating some implementations. Many other configurations of computing device 210 are possible having more or fewer components than the computing device depicted in FIG. 2.

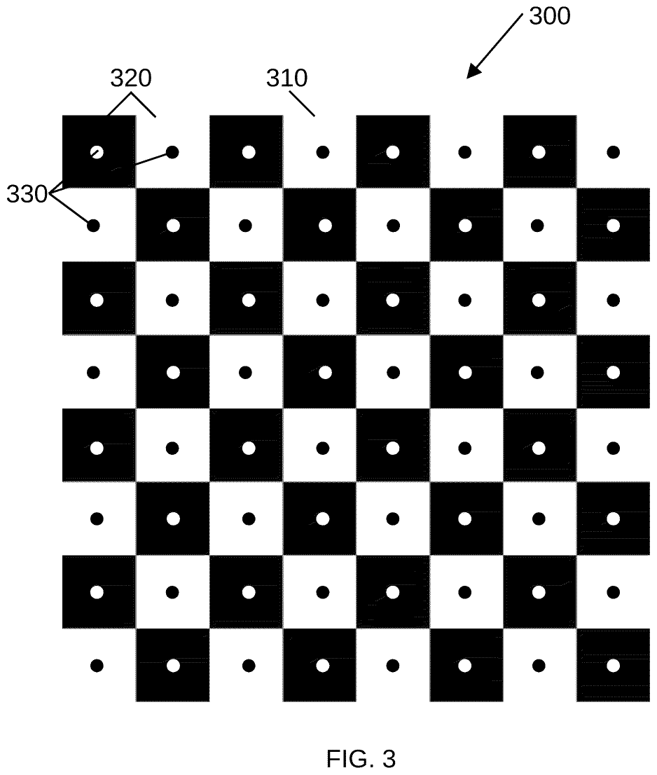

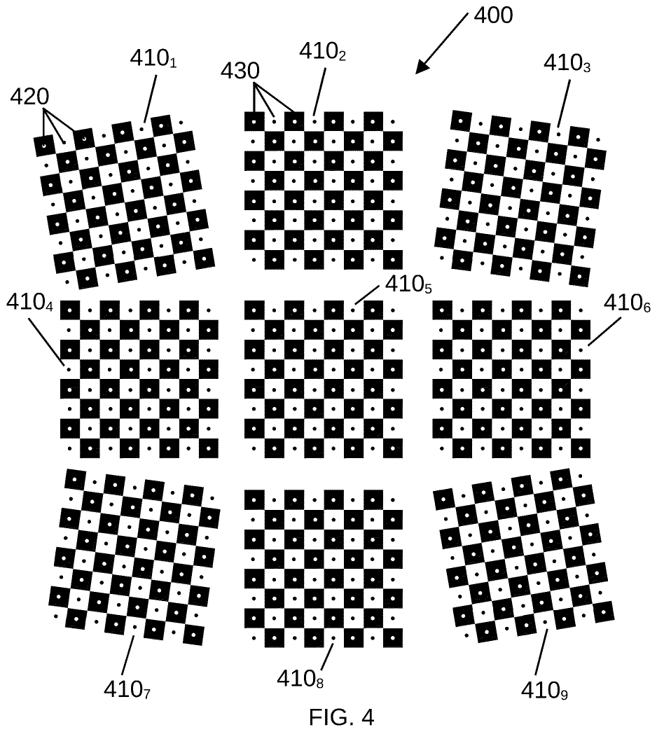

FIGS. 3 and 4 illustrate various, non-limiting, examples of calibration target arrangements 300, 400 on which IR emitters can be arranged. FIG. 3 is an example of a calibration target 300 in the form of a checkerboard pattern 310. This checkerboard pattern 310 includes alternating white and black squares 320 of equal size, such that the black and white squares (or portions thereof) within the pattern can be used as control points in the calibration process. In some instances, these control points can be detected in an image taken from a camera (not illustrated in FIG. 3). Disposed in the center of each of the black and white squares 320 is an IR emitter 330. The IR emitter 330 is represented in FIG. 3 as circular, but this is not intended to be limiting. As discussed previously with reference to FIG. 1, the IR emitters 330 may also be square or any other suitable form of IR emitter. Although FIG. 3 includes sixty-four IR emitters 330 (one per square on the eight-by-eight checkerboard calibration target 300), this is not intended to be limiting. The number of IR emitters can be dependent on the size of the checkerboard pattern.

FIG. 4 is another example of a calibration target, where the calibration target 400 includes a plurality of checkerboard patterns 410₁₋ₙ of FIG. 3. The IR emitters 420 are disposed once again in the center of squares 430 of each of the checkerboard patterns 410₁₋ₙ. Each of the calibration targets 300/400 can be placed near a camera, such as camera 105 (FIG. 1) to perform camera setup, image acquisition, and/or calibration. IR emitters 320/420 can emit infrared radiation. This infrared radiation may be picked up by the LWIR camera and used to determine intrinsic parameters of the camera, e.g., focal length, principal point, distortion, etc., and a radial distortion. The captured thermal image may then be processed by a processor, for example of the computing device 210, to determine extrinsic parameters (e.g., 3D rotation and translation) of the LWIR camera.

Although not illustrated herein, there may be additional configurations of a calibration target consistent with the description herein. For example, the calibration target may also be a three-dimensional shape, such as a cube or a sphere. In such embodiments, the IR emitters may be embedded into these three-dimensional shapes and may be used with the calibration of multiple LWIR cameras.

Regardless of the specific design of the calibration target 300/400, the IR emitters 320/420 are disposed at a specific distance from each other, for example in a grid formation, such as illustrated in FIGS. 1 and 3-4. A specific distance between the IR emitters 111 and the control points (e.g., the black and white squares, or portions thereof, within the pattern) is determined. IR energy from the active IR emitters 320/420 can appear as, for instance, a circular shape on a captured image. This circular pattern is due to omnidirectional thermal dispersion from the IR emitters. A computer device or processor can then execute the calibration instructions to control the LWIR camera to read the image acquired at the LWIR camera. The computer device or processor can detect this circular pattern depicted for each of the plurality of active IR emitters 320/420 on the calibration image. The center or centroid of each pattern generated by the IR emitters 320/420 may be determined in various ways. With a circular pattern, for example, the center may be found by identifying the center point of the circle. If the pattern is a polygon, the centroid may be found using a geometric algorithm, such as by calculating the average of all the x-coordinates and the average of all the y-coordinates of the polygon's vertices. For an elliptical pattern, the centroid may be found by identifying the intersection point of its major and minor axes. The center or centroid may then be used to estimate camera calibration intrinsic and distortion parameters for the camera.

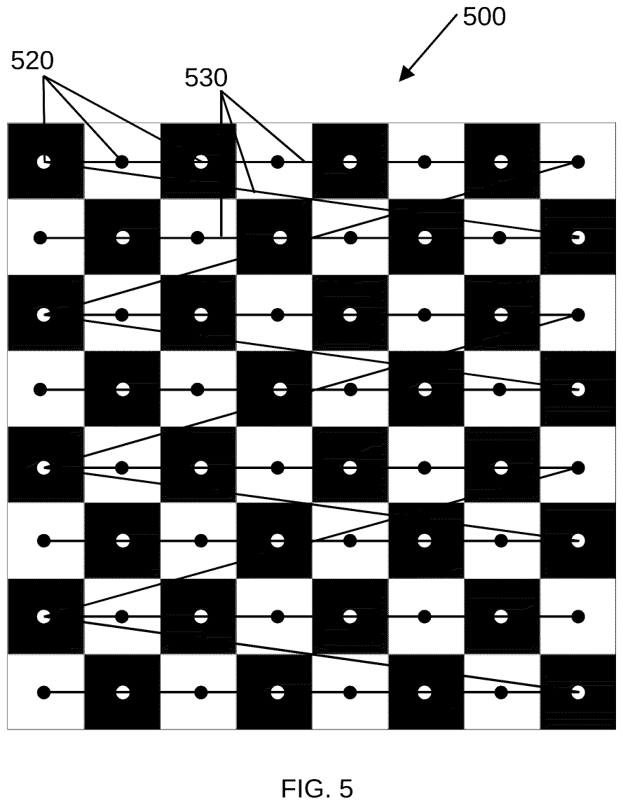

FIG. 5 illustrates a calibration target 500 (similar to that of FIG. 3) with a variety of calibration control points from the detection of IR emitters 520 according to some implementations. These control points may be a corner of the board or calibration target 500, a corner of one of the black and white squares of the calibration target 500, or the like. A centroid of each active IR emitter 520 can be determined by analyzing an image captured by the LWIR camera, (e.g., camera 105 of FIG. 1). Each of the active IR emitters 520 has a corresponding centroid that can be determined, for example, using geometric algorithms. A distance, as illustrated by lines 530 in FIG. 5, between the centers of some of the IR emitters 520 can be used as additional control points for the analysis. Geometric algorithms for finding a horizontal line between the IR emitters 520 can be used, along with the centroids, to estimate the intrinsic parameters and radial distortion of the camera (e.g., camera 105 in FIG. 1). Based on the determined control points 510, the computing device 210 can estimate the intrinsic parameters (e.g., focal length, principal point, distortion, etc.) and a radial distortion of the camera 105 (see FIG. 1) with respect to the active IR emitters 520. The determined intrinsic parameters and radial distortion of the camera 105 can then be utilized by computing device 210 to determine the extrinsic parameters (e.g., 3D rotation and translation) of the LWIR camera 105 with respect to the active IR emitters 520. The extrinsic parameters for the LWIR camera 105 with respect to the active infrared emitters 520 can then be utilized to transform images captured by the camera 105 to a common coordinate system.

If the intrinsic and extrinsic parameters determined by the computing device are applied to the originally captured image these control lines 530 should be straight, as opposed to a curved or otherwise distorted. Use of control lines, such as depicted in FIG. 5, allows for validation that the application of the transformation in view of the determined intrinsic and extrinsic parameters is working as intended.

FIG. 6 illustrates an example method 600 of actively calibrating a camera such as LWIR camera 105 of FIG. 1. The method 600 can be implemented by a computing device (e.g., computing device 210 of FIG. 2) or a controller. FIG. 6 illustrates the functionality and operation of possible implementations of systems, methods, and computer program products according to various implementations. In this regard, each block can represent a module, segment, or portion of code, which includes one or more executable instructions for implementing the specified logical function(s). It should also be noted that in other implementations, the functions noted in the blocks may occur out of the order noted in FIG. 6. For example, two blocks shown in succession in FIG. 6 may in fact be executed substantially concurrently or the blocks may sometimes be executed in the reverse order, depending on the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In some implementations, the method 600 begins, at block 610, with the activation of at least one of a plurality of IR emitters placed in a specific location on a calibration target to emit infrared radiation. In some implementations, the IR emitters disposed on the calibration target may be controlled by a computing device (e.g., computing device 210) in order to activate one or more of the at least one of a plurality of IR emitters. In other implementations, the calibration target may include one or more binary on/off switches to control activation of one or more of the at least one of a plurality of IR emitters.

At block 620, the method includes reading or capturing an infrared image by the camera when the infrared emitter emits the infrared radiation. This operation may be controlled by a computing device (e.g., computing device 210). At block 630, an image smoothing filter may be applied to the image. For example, a Gaussian smoothing may be performed, which allows for calculation of a weighted average of surrounding pixels based on the Gaussian distribution. Because the camera is able to detect the black and white of the calibration target, as well as dial of infrared emitter (the position of which is known), the image can be smoothed for ease in detection of patterns/shapes. The energy emitted from the infrared emitters is depicted in the image as a bright white spot surrounding the location of the emitter, with the remainder of the background dark (e.g., gray). This bright-white spot is substantially circular patterned because of omnidirectional thermal dispersion from the IR emitters. The farther away from the infrared emitter, the weaker the signal will be and the darker the gray value in the image will be. At optional block 640, an intensity filter may be applied to the captured image in order to filter out the white pixels on the image and/or a high value pixel in order to make the image more suitable for pattern detection (see block 650).

At block 650, patterns (e.g., circles) may be detected within the smooth (and if applicable intensified) image. As mentioned previously, this pattern is a result of the omnidirectional thermal dispersion from the IR emitters. The circle or circular-like pattern resulting from the infrared emitters in the image may then be detected through the use of, for example, a Hough circle detection method. At block 660, the centroid of the circle or circular-like pattern may be extracted from the image, e.g., using various geometric algorithms or other techniques mentioned previously. At block 670, the extracted location of the centroid may be compared to the known center point of the IR emitter to determine a calibration of the camera. For example, the extracted centroid of the energy source (e.g., the IR emitters) being emitted in the LWIR camera image can be used as a control point for determining the intrinsic and extrinsic parameters of the camera. More specifically, this calibration may include an intrinsic camera calibration and/or extrinsic calibration. Applying the calibration through a pinhole camera model (or, alternatively, any other camera model) allows for the determination of the intrinsic parameters. These intrinsic parameters may then be mapped on top of the visual target for the camera to determine the extrinsic parameters between the LWIR camera versus the visual camera.

In some implementations, the LWIR camera calibration target may be additionally used to perform extrinsic calibration with other sensors, such as other cameras, LiDAR, radar, etc. The IR emitter described and utilized herein may also be utilized as a part of existing extrinsic calibration systems.

Several implementations described herein relate to methods for performing selected aspects of the present disclosure. Other implementations may include a non-transitory computer readable storage medium storing instructions executable by a processor to perform a method such as one or more of the methods described herein. Yet another implementation may include a control system including memory and one or more processors operable to execute instructions, stored in the memory, to implement one or more modules or engines that, alone or collectively, perform a method such as one or more of the methods described herein.

It should be appreciated that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

1. A system for actively calibrating a thermal camera, the system comprising:
a calibration target including a plurality of infrared (IR) emitters;
a thermal camera configured to capture a thermal image;
a computing device configured to:
detect a pattern for each of the plurality of active IR emitters depicted in the thermal image;
estimate a centroid of each pattern; and
determine, via the centroid of each pattern, one or more camera calibration parameters for the thermal camera.

2. The system of claim 1, wherein the computing device is coupled with the calibration target and is further configured to activate one or more of the plurality of IR emitters to disperse thermal energy.

3. The system of claim 1, wherein the computing device is coupled with the thermal camera and further configured to capture the thermal image.

4. The system of claim 1, wherein the computing device is further configured to compare the estimated centroid with a known location of a first of the plurality of IR emitters.

5. The system of claim 1, wherein the computing device is further configured to smooth the captured thermal image.

6. The system of claim 1, wherein the computing device is further configured to apply an intensity filter to the captured thermal image.

7. The system of claim 1, wherein the one or more camera calibration parameters for the thermal camera includes one or more intrinsic parameters.

8. The system of claim 1, wherein the one or more camera calibration parameters for the thermal camera includes one or more extrinsic parameters.

9. The system of claim 1, wherein the pattern detected is circular.

10. The system of claim 1, wherein the calibration target is a black and white checkerboard.

11. The system of claim 1, wherein the plurality of IR emitters operate withing a specific temperature range that corresponds with an operating temperature range of the thermal camera.

12. A method of actively calibrating a thermal camera in which a calibration target contains a plurality of infrared (IR) emitters wherein the plurality of IR emitters are disposed on a calibration target, the method comprising:
activating the plurality of IR emitters disposed on the calibration target to disperse thermal energy;
capturing, via the thermal camera, a thermal image of the calibration target;
detecting a pattern for each of the plurality of IR emitters depicted in the captured thermal image;
estimating a centroid of each pattern; and
determining, via estimated centroid of each circular pattern, one or more camera calibration parameters for the thermal camera.

13. The method of claim 12, wherein the determining one or more camera calibration parameters for the thermal camera further includes comparing the estimated centroid with a known location of a first of the plurality of IR emitters.

14. The method of claim 12 further comprises smoothing the captured thermal image.

15. The method of claim 12 further comprises applying an intensity filter to the captured thermal image.

16. The method of claim 12, wherein determining one or more camera calibration parameters for the thermal camera further includes determining one or more intrinsic parameters.

17. The method of claim 12, wherein determining one or more camera calibration parameters for the thermal camera further includes determining one or more extrinsic parameters.

18. The method of claim 12, wherein the pattern detected is circular.

19. The method of claim 12, wherein the calibration target is a black and white checkerboard.

20. The method of claim 12, wherein the plurality of IR emitters operate withing a specific temperature range that corresponds with an operating temperature range of the thermal camera.
